(19) United States
(12) Patent Application Publication
(10) Pub. No.: US 2006/0080096 A1
(43) Pub. Date: Apr. 13, 2006

(54) Signal end-pointing method and system

(76) Inventors: Trevor Thomas, Milton (GB); Beng Tiong Tan, Sawston (GB)

Correspondence Address: JOHN BRUCKNER, P.C., 5708 BACK BAY LANE, AUSTIN, TX, 78739, US

(21) Appl. No.: 11/238,844

(22) Filed: Sep. 29, 2005

(30) Foreign Application Priority Data
Sep. 29, 2004 (GB) GB0421642.0

(51) Int. Cl. G10L 19/14

(52) U.S. Cl. 704/234

(57) ABSTRACT

A method of improving pattern recognition accuracy is provided that uses a mechanism for locating a pattern within an input signal, such as provided by a telephone network. This operation is hard because of the variability of the signal that is likely to be received by the pattern recogniser. It will receive a large range of signal amplitudes, possibly embedded in a variety of background noises, and is required to produce its best hypothesis of the patterns in this signal. This invention concerns the identification of the location of the patterns within the input signal, which in some aspects uses feedback from the following pattern matcher, and in other aspects uses a pattern distance to noise distance ratio to determine the pattern identification. Other aspects are also described. It is important to accurately locate the pattern to be recognised as errors in the location of the pattern will result in errors in the recognition of the pattern. The patterns to be recognised are preferably human utterances.

### CROSS-REFERENCE TO RELATED APPLICATION

This application is related to, and claims a benefit of priority under one or more of 35 U.S.C. 119(a)-119(d) from copending foreign patent application GB0421642.0, filed in the United Kingdom on Sep. 29, 2004 under the Paris Convention, the entire contents of which are hereby expressly incorporated herein by reference for all purposes.

### BACKGROUND INFORMATION

1. Field of the Invention

The present invention relates to a method and system for identifying the end-point of a wanted signal for use with a pattern recognition process, such as, for example, identifying a spoken utterance within an audio signal for use with a speech recogniser.

2. Discussion of the Related Art

Computer-based speech recognisers are known in the art, and in particular for use within call-centre applications, wherein speech to be recognised is received over a voice (typically a POTS) channel. In such applications, the caller maintains a dialogue with the computer, where each take turns to talk to the other, either asking questions and responding to questions with information, or sometimes both. Dialogues of this type are characterised by each party speaking a sentence and then pausing for the other party to respond. For example, the computer might ask a question, e.g. “please tell me your account number” and then pause for the caller to respond with their account number, e.g. “123456789”. Such communication may be termed a “turn-based” dialogue, and is characterised by each party speaking in turn and pausing for a response from the other party. This is in contrast to other types of communication in which the talker is lecturing, or speaking a monologue, where, when the talker pauses, all of the listeners know that the talker is intending to continue without the need for them to speak to the talker.

Architecturally, a known speech recogniser can generally be represented as in FIG. 1. In this figure an input signal 100 comprising speech samples or speech feature vectors derived from speech samples by a signal processing unit (as is well known in the art) is input to an end point module 103. The end-point module, which may be embodied in hardware or preferably in software to be run by a computer, locates the portion 101 of the signal that contains the speech and passes this portion onto a recogniser module 104. A configuration or control module 105 is usually provided to control both the end pointer module and the recogniser module, and which is used to direct the overall operation of the recogniser. The output 102 of the recogniser module would usually be lists of words or sentences, and other associated information such as recognition confidence measures.

FIG. 2 is a picture of a typical speech signal showing the waveform of a single utterance. The utterance 200 can be seen to start at position 201 and end at position 202 in the signal. Also in this picture is a “click” 203 that is not part of the utterance, but an artefact produced from either the telephone or from the transmission network. An ideal end pointer would be able to locate the speech between the start and end points, points 201 and 202, and would pass just that material to the recogniser

With respect to the end-pointer module 103, the requirement of this stage is to identify the portion of the input audio signal received that contains the talker's speech. This is challenging because frequently the talker will be talking in a noisy environment, or the talker will be talking in bursts of speech with short pauses between each burst. The end point stage also needs to identify quickly the end of the talker's speech. If it is slow to identify the end of the speech, the talker may consider that there is a problem with the system, as it will appear to not have heard the caller.

For the recogniser, or pattern matching, module 104, the portion of the signal that has been identified to be speech is passed to the recogniser and recognition is attempted on the portion of speech. A successful recognition therefore consists of both a successful identification of the start and end of the talker's speech by the end-pointer, followed by a correct recognition of the contents of the speech by the recogniser. The performance of the overall speech recognition system depends heavily upon the performance of both the end pointer and the recogniser. If the end pointer fails to locate the correct portion of the signal, then a recognition error is certain to occur. Equally, if the end pointer decides too quickly that the talker has stopped talking, then a portion of the caller's speech will not be passed to the recogniser and so a recognition error will again occur. If the end pointer is too slow to locate the portion of speech, and actually passes too much speech to the recogniser, then there is the possibility that the recogniser will again make an error in the recognition operation as it is being presented with too much speech, and this might cause unwanted insertions of unspoken words into its recognition hypothesis.

The present invention intends to address at least some of the above identified problems.

### SUMMARY OF THE INVENTION

The present invention provides several aspects. In one aspect, the invention provides a method and system wherein properties of an input signal are monitored to determine changes in environmental conditions affecting the generation of the signal. If large changes are detected then a signal segmentation process using the system is re-calibrated to account for the changed conditions, and restarted. In view of this, from a first aspect there is provided a method of identifying portions of an input signal to be recognised in a pattern recognition process, the method comprising the steps of:—receiving an input signal to be recognised; segmenting the input signal to determine the portions to be recognised; and outputting the segmented portions to a pattern recogniser the method further comprising monitoring one or more properties of the input signal to determine if environmental conditions affecting the generation of the input signal have changed, and if such changes are detected, repeating the segmenting step.

Additionally, according to the first aspect there is also provided a system for identifying portions of an input signal to be recognised in a pattern recognition process, comprising:—receiving means for receiving an input signal to be recognised; segmenting means for segmenting the input signal to determine the portions to be recognised; and output means for outputting the segmented portions to a pattern recogniser; the system further comprising control means arranged in use to monitor one or more properties of the input signal to determine if environmental conditions affecting the generation of the input signal have changed, and if such changes are detected, cause the segmenting means to repeat operation.

In a second aspect, the invention provides a method and system for identifying portions of signals in which patterns to be recognised are represented which uses adaptive segmentation thresholds to detect such portions. In particular, the thresholds may preferably be set as a function of the signal energy, or advantageously as a function of distance measures between known noise or pattern models and the input signal portion. In view of this, from a second aspect the invention further provides a method of identifying portions of an input signal to be subsequently recognised by a pattern recognition process, comprising the steps of:—setting one or more segmentation thresholds in dependence at least in part on one or more measured properties of the input signal; detecting portions of the input signal using the set segmentation thresholds; wherein said segmentation thresholds are repeatedly adapted during the detection step in dependence on the measured properties of the input signal.

Additionally, from the second aspect there is also provided a system for identifying portions of an input signal to be subsequently recognised by a pattern recognition process, comprising:—control means arranged in operation to:—i) set one or more segmentation thresholds in dependence at least in part on one or more measured properties of the input signal; and ii) detect portions of the input signal using the set segmentation thresholds; wherein said control means is further arranged to repeatedly adapt said segmentation thresholds during the detection step in dependence on the measured properties of the input signal.

In a further aspect, the invention advantageously computes matching distances between a portion of an input signal and predetermined speech and noise models. The resulting matching distances can then be used to determine the existence of signal portions containing patterns to be recognised. In view of this, from a third aspect the invention further provides a method of detecting patterns to be subsequently recognised by a pattern recognition process within an input signal comprising patterns and noise, the method comprising: matching a portion of the input signal to one or more predetermined pattern models to determine a pattern matching distance therebetween; matching the portion of the input signal to one or more predetermined noise models to determine a noise matching distance therebetween; and determining if the portion of the input signal contains a pattern or noise in dependence upon the noise matching distance and the pattern matching distance.

Additionally, in the third aspect there is also provided a system for detecting patterns to be subsequently recognised by a pattern recognition process within an input signal comprising patterns and noise, comprising: pattern matching means arranged in use to:—i) match a portion of the input signal to one or more predetermined pattern models to determine a pattern matching distance therebetween; and ii) match the portion of the input signal to one or more predetermined noise models to determine a noise matching distance therebetween; and segmentation means arranged in use to determine if the portion of the input signal contains a pattern or noise in dependence upon the noise matching distance and the pattern matching distance.

From a fourth aspect the invention presents an advantageous arrangement wherein a segmentation process may communicate with and control a recognition process and vice verse. This allows the segmentation process to start a recognition process much earlier than might otherwise be the case, thus improving performance of a pattern matching process. Likewise, the recognition process may also control the segmentation process, for example to tell the segmentation process to re-segment a particular segmented signal portion in dependence on the recognition result. In view of such operation, from a fourth aspect there is provided a pattern recognition method, comprising:—a segmentation process for segmenting an input signal comprising patterns to be recognised into portions, each portion containing at least one pattern to be recognised; and a recognition process arranged to receive portions of the input signal from the segmentation process, and to recognise patterns contained therein; wherein the segmentation process and the recognition process exchange control messages therebetween during their respective operations so as to control the respective operations thereof.

Additionally, from the fourth aspect there is also provided a pattern recognition system, comprising:—a segmentation means for segmenting an input signal comprising patterns to be recognised into portions, each portion containing at least one pattern to be recognised; and a pattern recognition means arranged to receive portions of the input signal from the segmentation means, and to recognise patterns contained therein; wherein the segmentation means and the recognition means exchange control messages therebetween during their respective operations so as to control the respective operations thereof.

Moreover, from a yet further aspect the invention also provides a segmentation method and system which uses information from earlier segmentation processes on earlier utterances in the same session to initialise segmentation variables for use in a present segmentation process. This enables much quicker initialisation and hence operation than would otherwise be the case. In view of this, from a fifth aspect there is provided a method of detecting portions of an input signal containing patterns, for subsequent recognition in a pattern recognition process, the method comprising the steps of:—for a first portion to be detected in any particular recognition session, setting detection information usable to detect the portions in dependence on one or more properties of the input signal; and detecting the first portion using the detection information; the method further comprising, for subsequent portions to be detected in the same recognition session, using detection information from a preceding detecting step as at least initial detection information to detect subsequent portions.

Additionally, from the fifth aspect there is also provided a system for detecting portions of an input signal containing patterns, for subsequent recognition in a pattern recognition process, the system comprising control means arranged in operation to perform the following:—i) for a first portion to be detected in any particular recognition session, to set detection information usable to detect the portions in dependence on one or more properties of the input signal; and ii) detect the first portion using the detection information; the control means being further arranged, for subsequent portions to be detected in the same recognition session, to use detection information from a preceding detecting step as at least initial detection information to detect subsequent portions.

Further aspects and features of the invention will be apparent from the appended claims.

### BRIEF DESCRIPTION OF THE DRAWINGS

Further features and advantages of the present invention will become apparent from the following description of an embodiment thereof, presented by way of example only, and by reference to the accompanying drawings, wherein like reference numerals refer to like parts, and wherein:—

FIG. 1 is a block diagram illustrating the general architecture of a speech recogniser;

FIG. 2 is a graph of signal amplitude against time illustrating an example utterance;

FIG. 3 is a block diagram illustrating an end pointer according to the embodiment of the present invention;

FIG. 4 is a state diagram illustrating the operation of the end-pointer of the embodiment of the present invention;

FIG. 5 is a graph of an input signal against time illustrating the use of thresholds within the embodiment of the present invention;

FIG. 6 is a graph of input signal against time illustrating the thresholds used within embodiments of the present invention;

FIG. 7 is a graph of signal against time illustrating the thresholds used within embodiments of the present invention;

FIG. 8 is a graph of signal against time illustrating a further aspect of the present invention;

FIG. 9 is a block diagram of the speech and noise pattern matcher module used in the described embodiments of the present invention;

FIG. 10 is a graph of input signal to be recognised against time illustrating the thresholds used within embodiments of the present invention;

FIG. 11 is two graphs of input signal against time illustrating aspects of embodiments of the present invention;

FIG. 12 is two graphs of input signal against time illustrating aspects of the present invention; and

FIG. 13 is a block diagram of a computer system forming an embodiment of the present invention, and illustrating the connections thereinto, as well as the computer program and data stored thereby.

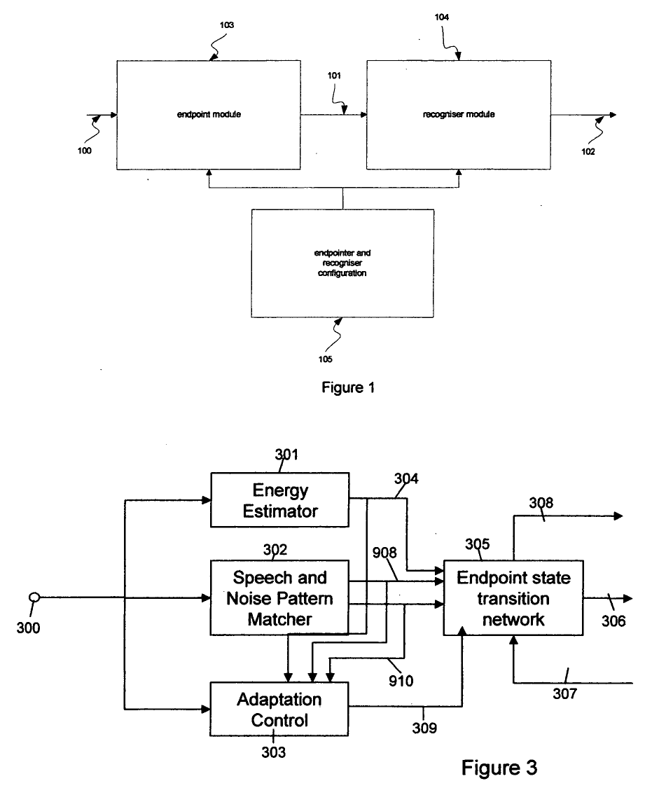

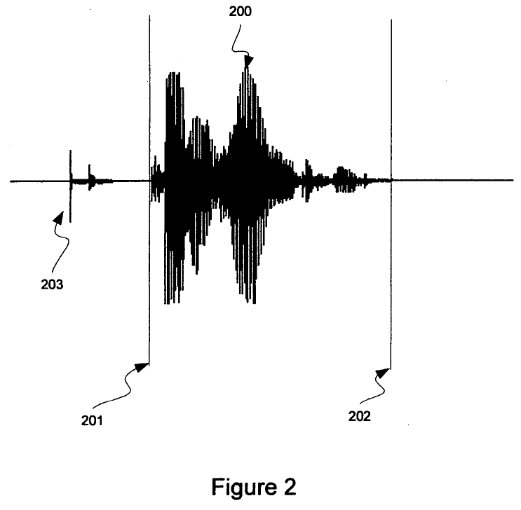

### DESCRIPTION OF THE PREFERRED EMBODIMENT

An embodiment of the present invention will now be described with respect to FIGS. 3 to 13.

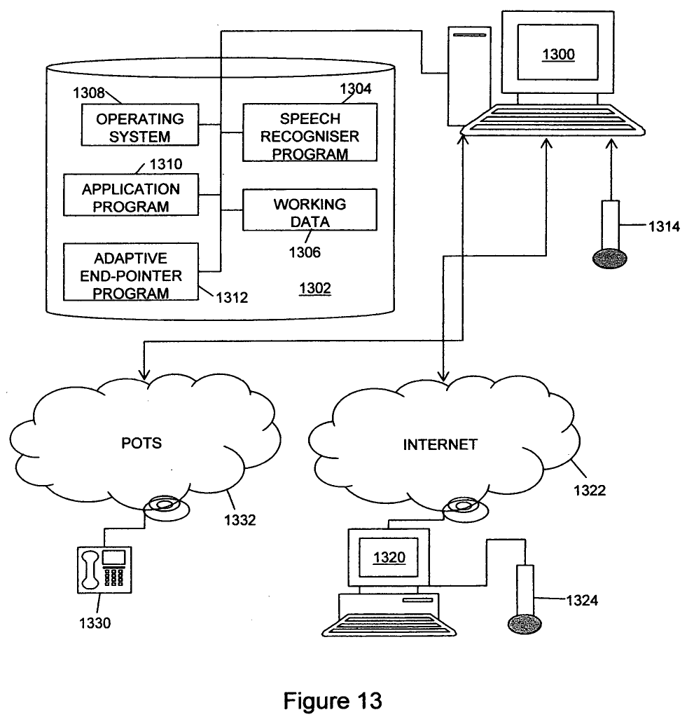

FIG. 13 is a block diagram illustrating a computer system which may embody the present invention, and the context in which the computer system may be operated. More particularly, a computer system 1300 which may be conventional in its construction in that it is provided with a central processing unit, memory, long term storage devices such as hard disk drives, CD ROMs, CD-R, CD-RW, DVD ROMs or DVD RAMs, or the like, as well as input and output devices such as keyboards, screens, or other pointing devices, is provided. The computer system 1300 is, as mentioned, provided with a data storage medium 1302, such as a hard disk drive, floppy disk drive, CD ROM, CD-R, CD-RW, DVD ROM or RAM, or the like upon which is stored computer programs arranged to control the operation of the computer system 1300 when executed, as well as other working data. In particular, operating system program 1308 is provided stored on the storage medium 1302, and which performs the usual operating system functions to enable the computer system 1300 to operate. Additionally provided is an application program 1310, which is a user application program to enable a user of the computer system 1300 to perform tasks enabled by the application program. For example, the application program 1310 might be a word processing application such as Microsoft® Word® or the like, or it may be any other application, such as a web browser application, a database application, a spreadsheet application, etc. Additionally provided in accordance with embodiments of the invention is a speech recogniser program 1304 which when executed by the computer system 1300 operates to recognise any input audio signals input thereto as speech, and to output a recognition signal, usually in the form of text, indicative of the recognised speech. An adaptive end-pointer program 1312 is also provided, which when executed by the computer system 1300 receives an input audio signal, and identifies those portions of the input signal which perhaps correspond to spoken utterances. The portions of the signal thus identified by the adaptive end-pointer program 1312 are passed to the speech recogniser program 1304 as input thereto. During its operation under the control of any of the previously described programs, the computer system 1300 may store intermediate results in the form of working data in working data portion 1306 of the storage medium 1302. Likewise, input data to any of the previously described programs, or output data therefrom, may also be stored in the working data area 1306.

As discussed above, the computer system 1300 may find operation in many different applications, according to the application program 1310 stored thereon. For example, the computer system 1300 may find application within a call centre environment, wherein, for example, the application program 1310 is a call centre dialogue application, which controls a dialogue with the user during a telephone conversation between the user and the computer system 1300. For example, the application program 1310 may be a dialogue manager for a banking system or the like, and which enables voice based telephone banking. In such a case, the computer system 1300 may be provided with a modem or the like connected to the plain old telephone system (POTS) 1332, through which users may contact the computer system 1300 via telephones 1330. With such operation, a user uses a telephone 1330 to dial a number which causes the POTS to connect the telephone to the computer system 1300, and the dialogue manager application program 1310 causes the computer system 1300 to answer the call, and to provide recorded information to prompt the user for spoken information. Where a user prompt is issued, and the user in turn speaks the prompted information, the dialogue manager application program 1310 may record the audio signal containing the user's utterance received at the computer system 1300, and then pass the received input signal to the adaptive end-pointer program 1312 so as to identify those portions of the input signal which contain speech. The thus identified portions are then passed to the speech recogniser program 1304 for recognition, and any recognition thus obtained passed back to the application program 1310 for further processing thereby. Thus, for example, in a banking application, a user utterance containing the users' account number may be received, which utterance is then identified by the end-pointer program, and recognised by the speech recogniser program, with the account information then being passed to the application program which may then provide further information to the user.

Of course, connection to the computer system 1300 for such a call centre based application need not be over the POTS, and may take place, over, for example, the Internet via a user computer 1320 provided with an input device such as a microphone 1324. In such a case, the computer system 1300 is provided with a network connection to enable it to connect to the Internet, such as a local area network card, a T1 connection, or the like. Receipt of user utterances via the Internet may be via any appropriate voice over IP (VoIP) protocol. Example operation of the application program 1310, the adaptive end-pointer program 1312, and the speech recogniser program 1304 to handle, identify and recognise any received input audio signal will be substantially identical to the case where it is received over the POTS.

Instead of a call centre application, the application program 1310 might be, for example, a word processing application, as mentioned previously. In such a case the computer system 1300 is preferably provided with an audio input device such as the microphone 1314, into which a user may speak, and hence the user's utterances captured by the application program 1310. Once the application program 1310 has captured the user utterance, it may then pass the input utterance signal to the adaptive end-pointer program 1312 so as to identify the portions of the input signal which contain the utterance, those identified portions then being passed to the speech recogniser program 1304, for recognition. The recognition result is then passed back to the application program 1310.

Having described the context of the use of embodiments of the present invention, further details of the operation of the adaptive end-pointer program 1312, to which embodiments of the present invention relate, will now be described.

With reference to FIG. 3, an input signal 300 received by the adaptive end-pointer program 1312 from the application program 1310 is subject to three separate signal-processing steps. In step 301, the energy estimator step, the signal is segmented into short periods, typically periods of 10 ms in length, and the short-term energy in the signal for each of these periods is calculated. Experience has shown that the short-term energy is a valuable device for giving crude location information around the location of the speech. In step 302, the speech and noise pattern matching step, the signal is also segmented into short periods and then the likelihood that the signal in the short period contained either the caller's speech or something else is calculated. Step 303, the adaptation control step, constantly monitors the speech and the assumptions made by steps 301 and 302 and can modify the decisions made by those steps depending upon the environmental history of the signal that has so far been received. Steps 301, 302, and 303 preferably operate repeatedly in parallel, but may be arranged to operate sequentially in turn.

The output of these three steps is used to control a state transition network 305, that is used to determine whether the caller is talking or not, the operation of which is described later. Signal 307 is feedback from the recogniser to the state transition network 305 of the end pointer. This feedback informs the end pointer whether the currently hypothesised speech segment is complete, whether the end pointer should expect the caller to say more, or whether the speech segment is not likely to be a speech segment from the caller but is probably noise.

Returning to a consideration of step 301, here an estimation of the short-term energy in the portion of the signal that is presently being examined is undertaken. There are many ways to make this calculation, but within the described embodiment the input waveform is split into portions, where each portion of signal is represented by x(t), where t is time. Typically, for signals derived from a telephone, each portion of speech is 10 ms long and contains 80 samples. The energy for each portion may then be calculated using:

$$energy = {\sum }_{t = 1}^{T} {x}^{2} ( t )$$

in the time domain or, alternatively, within the frequency domain as:

$$energy = {\sum }_{j = 1}^{J} {FFT}_{j}^{2} ( x )$$

where FFTⱼ(x) is the j^{th} coefficient of the Fourier Transform of the signal x(t)

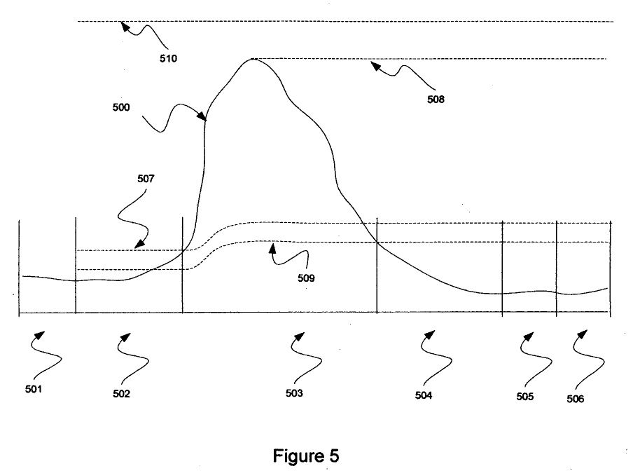

The result is that an estimate 304 of the energy of the signal for each portion of the input waveform is passed on to the end point state transition network module 305 in FIG. 3. This energy estimation can be plotted against time to help visualise the process. Curve 500 in FIG. 5 is such an example. The value of the energy is larger when the talker is actually speaking (during period 503), and this information is used to help the end point state transition network locate the start and end of the speech.

In addition to using an energy estimation over regular intervals of the input waveform, within the described embodiment we also calculate further information to help the end point state transition network locate the start and end of the speech. This further information is a number that is calculated over the same intervals as the energy estimation, and is a measure of whether the portion of the signal being processed is actually speech or silence. This measure is used to distinguish between background noise and speech within the end point state transition network processing, something that the energy parameter by itself cannot do. The measure is obtained by the speech and pattern matching step 302, using pattern matching between the input waveform portions and predefined speech and noise pattern models, as described further below with respect to FIG. 9.

Within FIG. 9, an input signal 900 representing the portion of the input waveform presently being processed is converted by a Fourier Transform (step 902), into a frequency spectrum signal 901. This spectrum is then converted into a cepstrum signal 905, using a cepstrum transform (step 903). In particular the cepstrum of the signal is computed as:

$$cepstrum ( i ) = {\sum }_{j = 1}^{FFTSize} cos ( \frac{ij π}{FFTsize} ) {log}_{e} ( {FFT}_{j} ( x ) )$$

The cepstrum signal is then subject to two pattern matching steps, steps 907 and 909. The operation of these pattern matching steps is similar in many respects to the operation of the speech recogniser proper, however, the pattern matchers in this case just need to examine each short period of speech in isolation and therefore take no account of the time varying information that is essential to speech recognition pattern matchers. In view of this, the pattern matching steps 907 and 909 compare the cepstrum signal 905 with a dictionary of predetermined cepstra that are known to contain either speech or noise. A dictionary 906 of models of speech sounds and a dictionary 904 of example noise sounds are provided to store the predetermined speech and noise models. Typically each of the dictionaries contain between 30 and 60 reference models. The result of the computations of the pattern matching steps 907 and 909 is a pair of numbers that represent the similarity of the input signal to either speech or noise as respective distance values. If one of these distance values is small, then the input signal is very similar to either speech or noise, depending upon whether signal 908 (output from pattern matching step 907) or 910 (output from pattern matching step 909) is the small value. Likewise, if both distance values are large, then we conclude that the input signal is unlike either speech or noise.

To compute the distance between the cepstrum 905 and the dictionary of cepstra, either of 904 or 906, within the described embodiment the minimum distance is used when the distance is computed between the cepstrum 905 and each of the dictionary cepstra, in accordance with the following:—
computed_distance=min(D(c,dⱼ))
where c is the cepstrum, 905, and dⱼ is the j^{th} cepstrum from the dictionary of cepstra, either 904 or 906, and where D(c,d) is given as follows:—

$$D ( c , d ) = {\sum }_{i = 1}^{I} {( {c}_{i} - {d}_{i} )}^{2}$$

where I is the dimension of the cepstrum vector.

For a typical system, the input signal may be silence, speech or noise, and so, during the portion of the time when the caller is talking the value of the speech distance, 908, is small, while the value of the noise distance, 910, is large. The opposite will be true when the input signal is just noise. When the input signal is silence, then neither distance will be either small or large. The speech and noise distance values are both passed to the state transition network 305 as inputs thereto.

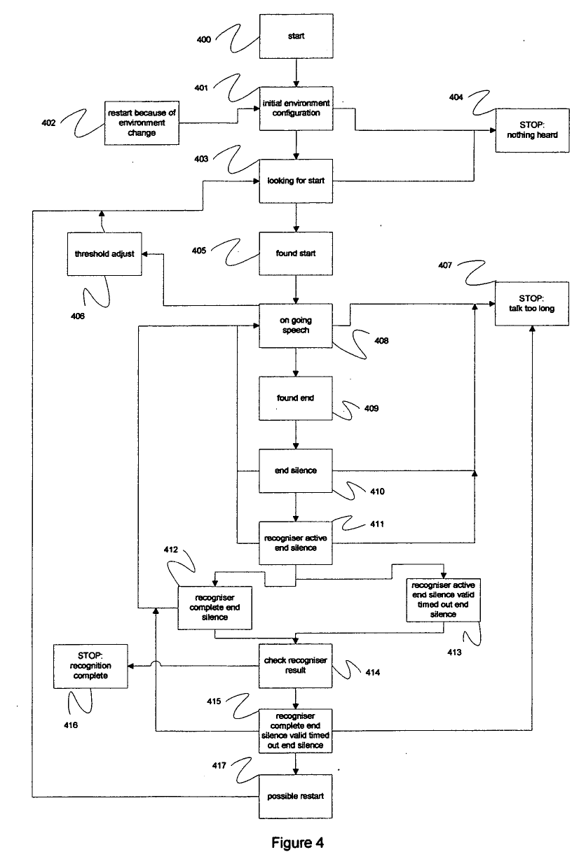

Returning to FIG. 3, throughout the processing of the input signal by the energy estimation step 301 and pattern matching step 302 the adaptation control step 303 is also performed. This step constantly monitors the values 304, 908, and 910 output by the energy estimator 301 and the speech and noise pattern matcher 302, to determine if gross environment changes have taken place during the recognition. If gross changes are identified, then the endpoint state transition network state is set to the “restart because of environment change” state (shown as state 402 in FIG. 4, and described later). Setting this state causes the end pointer to re-calculate its thresholds and restart processing of the input signal. Calculation of the end-pointer thresholds is described later.

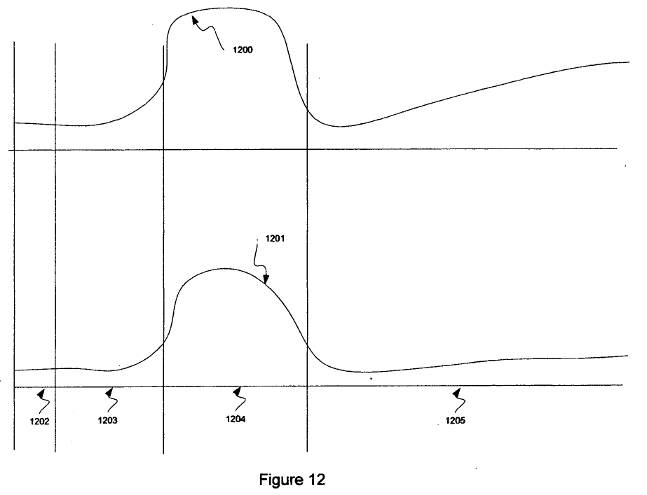

More particularly, the primary operation of the adaptation control step 303 is to monitor the combination of the energy waveform (304) and the ratio of noise distance/speech distance waveform (the ratio of signals 910 to 908) to identify areas where the energy waveform is rising above its smallest level without a similar rise in the noise/speech distance waveform. If this happens, then the assumption will be that the background noise levels have changed and a complete restart is needed to reset the parameters. FIG. 12 contains an example when this would happen. In FIG. 12, waveform 1200 is the energy waveform and waveform 1201 is the ratio of noise distance to speech distance. Period 1202 is an “initial environment configuration” state of the end pointer. Here this module records the levels of the energy and noise/speech ratio waveforms for later use, as described later. Period 1203 is a “looking for start” state, where the end pointer is looking to see if there is speech in the signal. Period 1204 contains speech, and this section is identified as such because both the energy and the noise/speech ratio waveforms rise in level. Period 1205 should be silence, but the energy waveform is rising in level while the noise/speech ratio waveform is not. This is detected by the adaptation control step from the inputs 304, 908 and 910 provided by the energy estimation and speech and noise pattern matching steps, and a control signal 309 sent to the end point state transition network 304. Receipt of the control signal 309 by the state transition network then causes a restart of the end point operation using the values from period 1205 of the waveform as background noise values for setting the adaptive thresholds used by the network, rather than those waveform values in period 1202.

This adaptation control step also provides the ability for the controlling application (such as application program 1310, or an internal control routine for the end-pointer) to send to the end pointer configuration information that was made available by the end pointer at the end of a previous utterance. This information is then used as a source for the configuration of the threshold parameters for the current utterance, rather than using the perceived background noise of the input waveform. This facility is preferably used in a dialogue for all recognitions after the first recognition. At the end of the first recognition, the controlling application is sent configuration information concerning the values of the end point thresholds that were used for that recognition. The controlling application sends this information back to this module at the beginning of the next recognition, and the received information is then used to set the end-pointer threshold values for the present recognition operation, in a manner described later. Such an arrangement is found to considerably speed up end pointer configuration and to increase the accuracy of the end pointer operation.

Turning now to FIG. 4, the operation of the end point state transition network will be described. The endpoint state transition network determines the location of the caller's speech within the input signal to the end-pointer. It also uses feedback from the speech recogniser to determine whether it has indeed located the speech correctly or whether it needs to try again. As shown in FIG. 3, the inputs to the end point state transition network 305, are:
i) the energy waveform, 304, derived from the input signal through the energy estimation step, 301;
ii) the speech (908) and noise (910) distance measures from the speech and noise pattern matching step 302;
iii) information (309) about the overall energy levels of the signal produced by the adaptation control step 303; and
iv) feedback information 307 from the recogniser informing the end point state transition network whether it has completed its task or whether it needs to either continue looking for more speech or to restart itself, abandoning what it has already found to be speech.

The output 306 of the endpoint state transition network is a segment of speech that is passed to the recogniser, and control information 308 that the controlling application may use to tell whether any speech was identified or whether the end pointer stopped listening to the speech because it had run out of time.

The endpoint state transition network of the preferred embodiment has 18 states, illustrated in FIG. 4. The operation starts in the start state, 400. The transition from state 400 to state 401, the initial environment configuration state, occurs when the end pointer is instructed to start processing by the controlling application.

The state transition network remains in state 401 until one of two observations occur. It will transit to state 404, a state that, if reached, signifies that the end pointer has heard no speech before a pre-specified time out (such as, for example, 2 seconds) has been reached. It will only transit to this state if it has arrived in state 401 from state 402, which is a forced restart of the processing because of changed environment conditions, as determined by the adaptation control step 303, and communicated via the control signal 309. It will, however, usually transit to state 403, the “looking for start” state, after a short period of time. While in this state, the algorithm will observe the three input signals 304, 908, and 910 and compute initial estimates of thresholds that it will use to determine its behaviour throughout the rest of the process.

There are three thresholds of importance. The upper threshold is the threshold above which the signal is deemed to contain speech, while the lower threshold is set such that a signal below it is treated as either silence or noise. There is also a threshold higher than the upper threshold, the “threshold adjust” threshold. This threshold is used to restart the end-pointer should the initial configurations prove to be wrong. All of these thresholds will vary throughout the course of the recognition.

FIG. 5 is a diagram describing the way these parameters might change throughout the processing of an utterance. In this figure, waveform 500 represents the energy waveform for an utterance. This waveform has been segmented into the periods 501,502,503,504,505 and 506, which all represent various states the end point state transition network will pass through to process the signal. Period 501 is the initial environment configuration state. At the completion of that state's processing, the endpoint state transition network will transit to state 403, “looking for start”, which is represented by the portion of the signal 502 in FIG. 5. The two thresholds are now presented in FIG. 5. The upper threshold is line 507. This is the threshold above which the signal is thought to contain speech. The lower threshold is line 509. Signals below this line are thought to contain silence. The “threshold adjust” threshold is line 510.

The setting of the three thresholds will now be described. All are initially set from the waveform level during the “initial environment configuration” state, state 401. Because of the operation of the adaptation control module, the setting of these parameters is performed either without any knowledge of the signal, this would be done for the first utterance to be recognised, or would be set based upon information passed to the end pointer from the controlling application prior to the recognition for all subsequent utterances of the same recognition session. The difference is that for the first utterance, the maximum_energy needs to be calculated from the signal itself whereas for subsequent utterances, the value of the maximum_energy parameter is passed to the end pointer from the controlling application. The computation of the threshold parameters is as follows.

Firstly, the three inputs 304, 908 and 910 to the endpoint state transition network are combined into a single waveform for ease of processing. More particularly, the energy waveform, and the two distance measures are combined into a single waveform using

$$workingwaveform ( i ) = energy ( i ) \frac{noisedistance ( i )}{speechdistance ( i )}$$

where i is a time variable and workingwaveform(i) is the actual waveform used for processing. This equation successfully combines the important energy of the signal with the ratio of the two distances from the speech and noise pattern matcher. If the signal is very speech-like, then the speechdistance( ) will be very small, so effectively amplifying the energy in the signal. Conversely, if the signal is very noise-like, the noisedistance( ) will be small, thereby reducing the energy of the signal. This measure is therefore able to represent in a single waveform not just the energy of the signal, but also whether there is speech in the signal or not. This means that the process is robust against even high levels of background noise.

The workingwaveform(i) value thus obtained is monitored throughout the “initial environment configuration” state 401, and the maximum value thereof during that time determined to give a maximum_energy value:—

$$maximum\_energy = {max}_{i = length}^{i = 1} ( workingwaveform ( i ) )$$

The upper and lower threshold values are then set in accordance with the following logical conditions:—
i) if maximum_energy<1000 then
   lower_threshold=125−(1000−maxmimum_energy)*0.1
   upper_threshold=300−(1000−maxmimum_energy)*0.1
ii) if maximum_energy>1000 and <2000 then
   lower_threshold=125+(maxmimum_energy−1000)*0.1
   upper_threshold=400+(maxmimum_energy−1000)*0.1
iii) if maximum_energy>2000 and <4000 then
   lower_threshold=225+(maxmimum_energy−2000)*0.0625
   upper_threshold=500+(maxmimum_energy−2000)*0.25
iv) if maximum_energy>4000 and <8000 then
   lower_threshold=375+(maxmimum_energy−4000)*0.03125
   upper_threshold=1000+(maxmimum_energy−4000)*0.0625
v) if maximum_energy>8000
   lower_threshold=550
   upper_threshold=1250

The above calculations are repeatedly performed for each input signal portion during the “looking for start” state 403 and “on going speech” state 408. In particular, during the “on going speech” phase, the transition into “threshold adjust” (state 406) will occur if the maximum level of the input has been achieved. In the transition between “looking for start” and “on going speech”, the values of the upper_threshold and lower_threshold are stored. The maximum level is then repeatedly calculated to be the upper_threshold from the current speech segment when the current segment's lower_threshold exceeds the value of the upper_threshold that was stored at the transition between “looking for start” and “on going speech”.

The end point state transition network remains in state 403 until one of two events occur. Either the input signal does not rise above the upper threshold before the end point stops processing because it believes that the talker is not going to speak. If this occurs, then the end point transits to state 404, stopping in the “nothing heard” state. Conversely, when the talker actually starts to talk, the input signal rises above the upper threshold, and if it remains above the upper threshold for a short time, the “minimum talk duration” time, this will cause the state to transit to state 405, “found start”.

The “found start” state consumes no input signal, but is used to record the starting time of the speech, which will later be used to select the portion of the signal that is passed to the recogniser. No speech is passed to the recogniser until a particular condition in the “end silence” state 410 has been reached and the end point state transition network transits to state 411, the “pattern match active end silence” state, as described later. The “found start” state 405 therefore immediately transits to state 408, “on going speech” after recording the start time of the hypothesised speech segment.

The end point network will remain in the “on going speech” state 408 until one of three events occurs. During the occupation of this state, the upper and lower thresholds will also be adjusted based upon the maximum and minimum levels of input signal being processed. More particularly, with reference to FIG. 5, the upper threshold, 507, and the lower threshold 509, both rise as the maximum level of the input signal rises, the new level of the thresholds being determined by the application of the equations and logical conditions set out above, for the present signal portion being processed. The algorithm remembers the maximum level of the signal that has so far been recorded, illustrated by line 508.

The state transition network will transit to state 409, “found end”, if the signal falls below the lower threshold, 509. This occurs on the line between periods 503 and 504 in FIG. 5.

State 408 might also transit to state 407, “talk too long”. This would happen if the algorithm has been listening a long time to speech and a limit was placed on the maximum amount of speech the recogniser could process. Typically this limit might be 20 seconds, and so would only be reached in extreme circumstances.

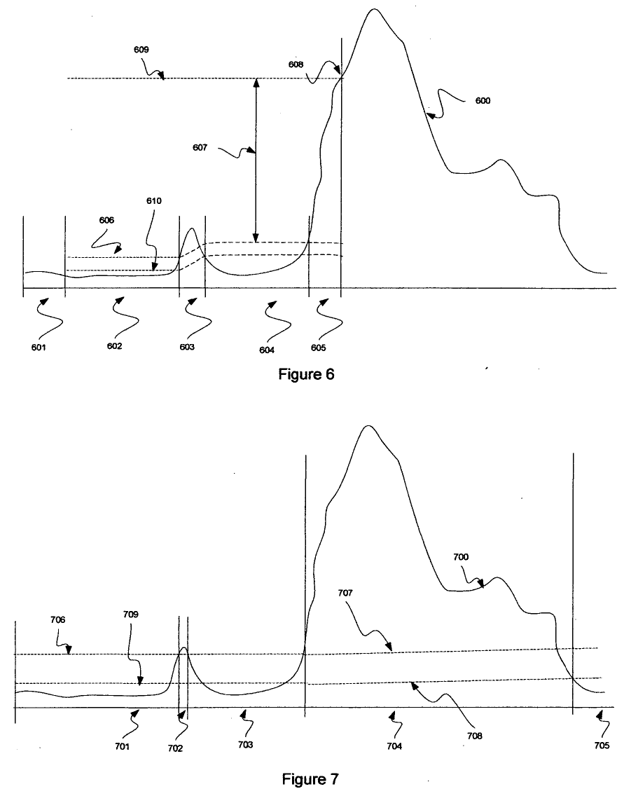

State 408 may also transit to state 406, “threshold adjust” if the maximum level of the input signal has risen above the further, higher, maximum threshold. This higher threshold is needed to account for possible quiet speech before the talker has actually started to speak. This event does not happen in FIG. 5, but does happen in FIG. 6, described later.

State 409, “found end”, is a state that consumes no input signal, but is used to record the end time of the speech portion that will later be passed to the recogniser in state 411. In FIG. 5, the “found end” state occurs between sections 503 and 504. The “found end” state always transits immediately to the “end silence” state, 410.

The purpose of the “end silence” state 410 is to process the input waveform to see if either the talker will start to speak again or if a time out occurs. If the caller starts to speak again, which is spotted by the input waveform again rising above the upper threshold level, the state will transit back to “on going speech”, 408. If the caller does not start to speak before the time out “end silence time out before starting recogniser” has passed, then the portion of speech identified by the start and end positions recorded in states 405 and 409 is passed to the recogniser, and processing passes to state 411, “recogniser active end silence” which causes the end pointer to start the recogniser. However, the end point state transition network will continue listening to the input signal and might direct the recogniser to stop processing the speech portion because the talker has re-started speaking.

To maintain accuracy and to reduce the effect of mis-locating either the start or the end points of the speech, the portion of speech passed to the recogniser is always extended in both directions by a small amount, perhaps 200 ms.

Alternatively, instead of transiting to state 411, state 410 may also transit to state 407, “talk too long” if the combination of the portion of the signal identified by the start and end points and the extra portions of the signal that are added on to each end of the signal is greater than the recogniser can process. This does not happen very frequently. For clarity, the part of the input signal in which the end point state transition network is in the “end silence” state is 504 in FIG. 5.

State 411, “recogniser active end silence” is the state in which both the end pointer believes the input signal to contain silence and the recogniser is processing the speech that was sent to it in the transition from state 410 to state 411. This state may transit to one of four other states, depending upon one of the following conditions occurring.

More particularly, state 411 will transit to state 408, “on going speech”, if the input waveform rises above the upper threshold, signalling that the talker has restarted speaking. If this happens, a control signal is sent to the recogniser to stop recognition and its result is abandoned.

Alternatively, state 411 will transit to state 407, “talk too long” in the rare case that more speech needs to be sent to the recogniser than can be processed by the recogniser.

In other cases, state 411 will transit to either states 412, “recogniser complete end silence”, or state 413, “recogniser active end silence valid timed out end silence” depending upon which of two independent events occurs first. More particularly, the state will transit to state 412, “recogniser complete end silence”, if it receives a signal from the recogniser that has completed its processing of the speech portion of the signal that was passed to it during the transition from state 410 to 411 before a further time out has elapsed. This time out, “end silence valid”, is a time out that represents the minimum time that the end pointer will wait before returning an answer to its controlling process. Typically the length of the “end silence valid” timeout should be between 0.3 and 1 second. It should be larger than the “recogniser active end silence” timeout.

Alternatively, state 411 will transit to state 413, “recogniser active end silence valid timed out end silence”, if the time out “end silence valid” elapses while the recogniser is continuing to process the speech portion.

Considering the above mentioned next states in turn, state 412, “recogniser complete end silence”, represents the state where the recogniser has completed its recognition of the portion of the signal that was identified as speech, but the end pointer is continuing to wait for the “end silence valid” time out to elapse. State 412 can therefore transit to two other states, depending upon the input conditions received by the end pointer. If the talker starts to talk again, then the processing state moves back to state 408, “on going speech”, and the recognition result is discarded. This happens because there was a pause between words that was long enough to start the recogniser, but not long enough to cause the end-pointer to stop listening for more speech. Alternatively, if no further speech is detected during the time-out, state 412 can transit to 414, “check recogniser result” if the “end silence valid” time out occurs.

Considering now State 413, “recogniser active end silence valid timed out end silence”, this state represents the position when the end pointer has listened to enough silence to know that, when the recogniser completes processing and it results in a valid answer, then the recognition is complete. This state will therefore transit to state 414, “check recogniser result” when the recogniser signals that it has completed processing the portion of speech it was given.

Considering now state 414, “check recogniser result”, this state consumes no input, and is used to check whether the result of the recognition is thought to be a valid result or not. This is useful in cases where the recogniser can be instructed to identify speech that is not part of its recognition grammar, for example, the speech might just be a cough. In such a case, the recogniser will signal to the end pointer that the portion of speech recognised did not result in a real recognition, and was most likely not speech. This state can therefore transit to two other states, as described below.

More particularly, state 414 will transit to state 416, “STOP: recognition complete”, if the result of the recognition is thought to be a valid result. Alternatively, it will transit to state 415 “recogniser complete end silence valid timed out end silence” if the result of the recogniser is not valid, but a final end time out has not yet elapsed. This time out, “end silence maximum”, is a longer time out than the other two time outs, “end silence time out before starting recogniser” and “end silence valid”, and represents the absolute maximum time the end-pointer will process the input signal before stopping and returning to the controlling process. The value of the “end silence maximum” timeout is preferably between 0.6 and 2 seconds for most kinds of utterances, and the value of the “end silence time out before starting recogniser” is preferably between 0.3 and 0.6 seconds.

Concerning state 415, “recognition complete and silence valid time out end silence” this state is entered when the recogniser has signalled to the end pointer that the recogniser has no valid result and that the end pointer should wait a little longer before stopping. This state will transit to one of three states depending upon its input.

More particularly, state 415 will transit to state 408, “on going speech” if the talker starts to speak. If this happens, the result of the recognition is abandoned. Alternatively, state 415 will transit to state 407, “talk too long” if there is too much speech for the recogniser to process. This should rarely happen. Finally, state 415 will transit to state 417, “STOP: recognition complete without valid result”, if time out “end silence maximum”, has elapsed without more speech being identified by the end-pointer. In such a case, the end-pointer may be re-started to try and process the input speech signal again, or to process later utterances.

There are two other states that the end point state transition network might enter, as described next.

State 406, “threshold adjust”, is entered from state 408 when the input signal is thought to have deviated greatly from the expected range as computed in the “initial environment configuration” state, state 401. This would typically occur if the input waveform rose above the maximum threshold 510 in FIG. 5. When this happens, all of the thresholds computed in state 401 are re-computed and the operation of the end-pointer is restarted in state 403, “looking for start”. The reason for this operation is to account for the huge range of input signals that the end pointer needs to be able to process. A quiet signal, such as signal 500 in FIG. 5 might be either some real speech from a quiet talker or just some background speech from a louder talker. In FIG. 6, section 603 represents the same waveform as 500 in FIG. 5, but drawn to a smaller scale. In FIG. 6 we see that the waveform 600 will rise to a much higher level and exceed the threshold adjust level at point 608. This would cause the end point state transition network to enter state 406.

The second state, state 402, “restart because of environment change”, might be entered at any time from any of the other states. This state would be entered if the input signal's range strayed outside the maximum ranges calculated in the initial environment configuration state, 401. This happens if there is a gross error in the calculations and a resetting of the end pointer is needed. The adaptation control step 303 monitors the signal level for such gross changes in conditions and signals the state transition network to enter state 402, as previously described.

Above we have described the operation of the end point state transition network as well as the energy estimation step 301, speech and noise pattern matching step 302, and the adaptation control step 303. Further example operation of these elements will become further apparent from the following description of end point operation for various input conditions.

The description of the end point operation above referred to the example of FIG. 5 to demonstrate a range of conditions in which the endpoint must operate. The end point of the present embodiment of the invention has to handle a greater range of input than those of FIG. 5, however, as will become apparent from the following.

With reference to FIG. 6 an input waveform 600 has been segmented to demonstrate other functions of the end pointer. Period 601 is during the initial environment configuration state 401 that results in the initial setting of the upper, lower and maximum thresholds, shown as lines 606, 610 and 609 respectively. Period 602 is during the “looking for start” state, 403. The end pointer then progresses into the “on going speech” state, state 408, via state “found start”, during period 603. Note here that during the period 603, the upper and lower thresholds increase. Period 604 is during the “end silence” state 410, reached because the input waveform fell below the lower threshold and was therefore classed as silence. At the junction between periods 604 and 605 the end pointer transits back to “on going speech” as the input waveform rises above the upper threshold again. At point 608, the input waveform achieves the maximum upper threshold level 609. At this level, the end pointer operation enters state 406, “threshold adjust”, which causes all of the thresholds to be re-calculated and the end pointing operation then restarted from the “looking for start” state 403.

To continue with the explanation, reference should now be made to FIG. 7, which shows the same input waveform as FIG. 6, but with markers that are used after the thresholds have been adjusted in state “threshold adjust” 406. The upper and lower thresholds have been adjusted to the levels at 706 and 709, and processing restarts from the beginning of the waveform. Period 701 is during the “looking for start” state. Period 702 contains material that is above the upper threshold, but is now too short to be considered speech, and so the end point state transition network remains in the “looking for start” state through period 703. At the end of period 703, the input waveform rises above the upper threshold and so the end point state transition network moves through the “found start” state 405 to the “on going speech” state 408, where it remains until period 705 starts and the “end silence” state 410 begins. Throughout the “on going speech” state 408, the upper and lower thresholds continue to be adjusted as necessary.

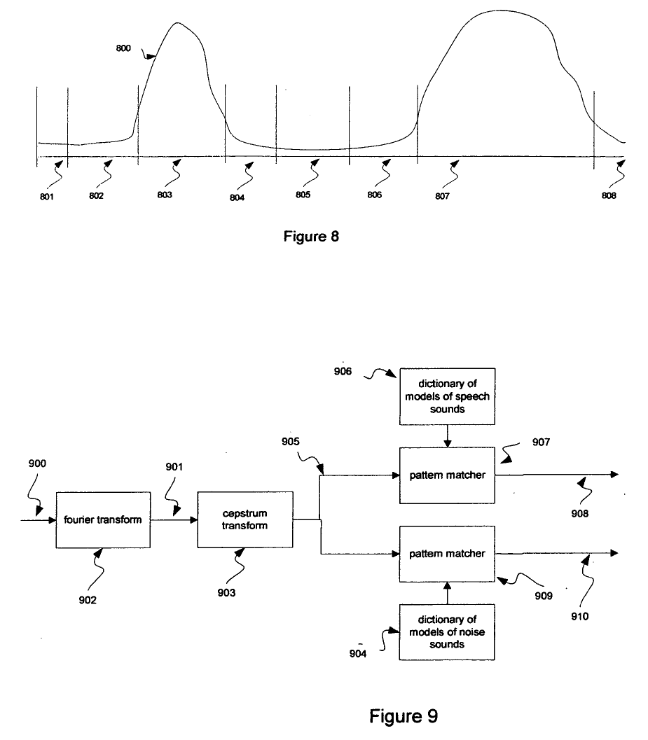

FIG. 8 demonstrates restarting of the end point process with the abandonment of the recognition request. Period 801 is the “initial environment configuration” state, state 401. The end pointer then moves into the “looking for start” state 403, for period 802. Speech is found and the state becomes “on going speech”, state 408, for period 803. When period 804 starts, the end pointer believes speech to have stopped and the state “end silence”, state 410, is entered. When the “end silence time out before starting recogniser” time out has elapsed, the recogniser is started and the state moves to state 411, “recogniser active end silence”, for period 805. The recogniser signals to the end pointer that it has completed its processing and the end pointer moves to section 806, into state “recogniser complete end silence”, state 412. Before the “end silence valid” time out has elapsed, the input signal rises above the upper threshold and causes the end pointer to abandon the recognition result as it moves back to state 408, “on going speech” to continue processing. This demonstrates an important effect of the end pointer. It can start the recogniser before the talker has certainly completed speaking, and is allowed to abandon the recogniser result should the talker restart speaking.

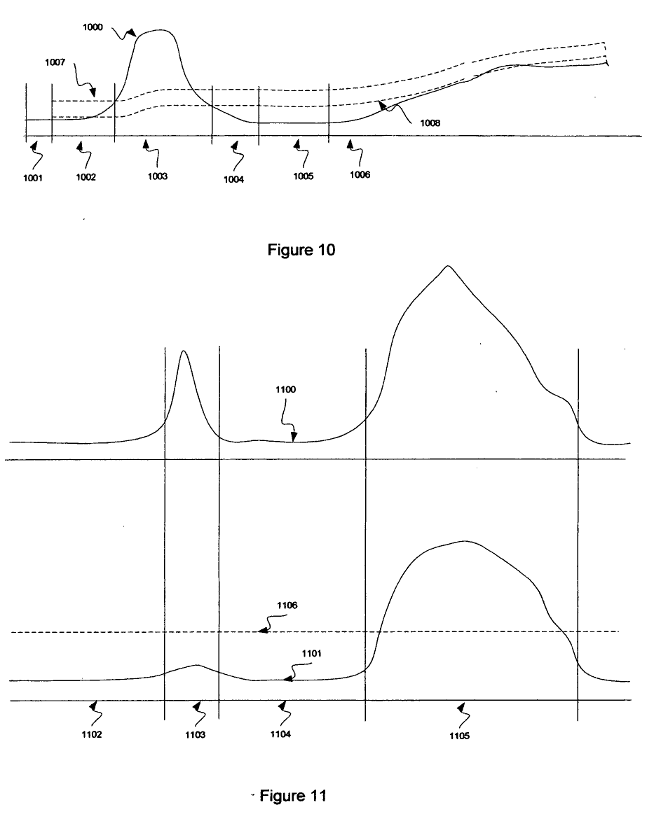

FIG. 10 demonstrates the modification of the upper and lower thresholds during the end silence phase (states 410 to 413) of the processing. During this phase it is often found that the background noise and speech rises in level. This rise is frequently because of the use of automatic gain controls in the telephone through which the talker is speaking. To accommodate this phenomenon, the upper and lower thresholds are increased during the end silence phase, thereby keeping the energy signal below the upper threshold and thus keeping the end pointer from considering the input signal as speech and so causing the recognised result to be abandoned. In this figure, period 1001 is the “initial environment configuration” state, state 401. Period 1002 is the “looking for start” state 403. Speech is then located in period 1003 and the end pointer moves into state 408 “on-going speech”. The speaker stops talking in period 1004, and at the end of period 1004 the recogniser has a speech segment passed to it for recognition. During this time the end pointer continues to process the input signal. In period 1006, both the upper threshold 1007, and the lower threshold 1008 rise in value. The rise may be step-wise or continuous, according to any appropriate substantially monotonic function, but is preferably calculated in accordance with the following.

When the “found end” state, state 409, is entered the current values of the upper threshold and lower threshold are recorded. Subsequently, during the end silence phases each time the input waveform is processed, each of the upper and lower thresholds are re-calculated according to
new_upper_threshold=0.9*last _upper_threshold+0.2*stored_upper _threshold
new_lower_threshold=0.9*last_lower_threshold+0.2*stored_lower_threshold
where last upper threshold is the value of the upper threshold the last time the calculation was made and stored_upper_threshold is the value of the upper _threshold stored while processing state 409, “found end”. Likewise, last_lower_threshold is the value of the lower_threshold the last time the calculation was made and stored_lower_threshold is the value of the lower threshold stored while processing state 409, “found end”. The last_upper_threshold and last_lower_threshold values are initialised to be the same as stored_upper_threshold and stored_lower_threshold values for the first iteration. The effect of the above is to cause the upper and lower thresholds to be increased during the end silence phases, which is significant because during this period the input signal also rises in value, but this rise is not due to the caller speaking, but due to the rise in background noise level because of the automatic gain control being used in the telephone. Because of the rise in levels of the upper and lower thresholds, the end pointer does not cause any more speech to be identified and the result is a correctly segmented input signal.

Finally, FIG. 11 demonstrates the modification of the sensitivities of the upper and lower thresholds when an input energy signal, 1100, and the ratio of noise distance/speech distance waveform, 1101, differ greatly in their classification of the input signal. In section 1103, the energy signal observes a large rise in energy, however the ratio of noise distance/speech distance sees no such rise. Under normal circumstances, the single waveform (workingwaveform(i)) used is a product of the energy waveform and the ratio of noise distance/speech distance, however, there are cases where the energy waveform is very loud and will override any value of the noise/speech distance waveform. Thus, the value of the noise/speech ratio is also considered in addition to the combined input, and if the ratio is too low (such as, for example, below 0.5), then the signal is classed as an exceptionally loud burst of noise and is ignored by the end pointer. Detection and consideration of this point is performed throughout the end-pointer operation, but principally within the “looking for start” state 403, the “on-going speech” state 408 and during those “end silence” states (410, 411, and 412) where speech is still looked for even though it is thought that the end-point of the utterance has been found.

Various modifications may be made to the above-described embodiment to provide further embodiments that are encompassed by the appended claims, which define the spirit and scope of the present invention. Moreover, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A method of identifying portions of an input signal to be recognised in a pattern recognition process, the method comprising the steps of:—
receiving an input signal to be recognised;
segmenting the input signal to determine the portions to be recognised; and
outputting the segmented portions to a pattern recogniser
the method further comprising monitoring one or more properties of the input signal to determine if environmental conditions affecting the generation of the input signal have changed, and if such changes are detected, repeating the segmenting step.

2. A method according to claim 1, wherein the one or more properties include the energy contained within the input signal.

3. A method according to claim 1, wherein the method further comprises matching a portion of the input signal to at least one predetermined noise model to determine a noise matching distance therebetween, wherein the one or more properties include the determined noise matching distance.

4. A method according to claim 3, wherein the method further comprises matching a portion of the input signal to at least one predetermined pattern model to determine a pattern matching distance therebetween, wherein the one or more properties include the determined pattern matching distance.

5. A method according to either of claim 4, and further comprising calculating a matching ratio of the noise matching distance and the pattern matching distance, wherein the one or more properties include the calculated ratio.

6. A method according to claim 5, wherein the monitoring step further comprises monitoring changes in the matching ratio and changes in the signal energy, and detecting changes in environmental conditions if the signal energy changes without a corresponding change in the matching ratio.

7. A method of detecting patterns to be subsequently recognised by a pattern recognition process within an input signal comprising patterns and noise, the method comprising:—
matching a portion of the input signal to one or more predetermined pattern models to determine a pattern matching distance therebetween;
matching the portion of the input signal to one or more predetermined noise models to determine a noise matching distance therebetween; and
determining if the portion of the input signal contains a pattern or noise in dependence upon the noise matching distance and the pattern matching distance.

8. A method according to claim 7, wherein the determining step comprises calculating a ratio of the noise matching distance to the pattern matching distance, and determining if the portion of the input signal contains a pattern or noise in dependence upon the calculated ratio.

9. A method according to claim 7, and further comprising the step of measuring the energy in the portion of the input signal, wherein the determining step further determines if the portion of the input signal contains a pattern or noise in dependence upon the energy.

10. A method according to claim 7, wherein the determining step comprises calculating a ratio of the noise matching distance to the pattern matching distance, and determining if the portion of the input signal contains a pattern or noise in dependence upon the calculated ratio, the method further comprising the step of measuring the energy in the portion of the input signal, wherein the determining step further determines if the portion of the input signal contains a pattern or noise in dependence upon the energy, wherein the determining step further comprises calculating a product of the energy and the calculated ratio, and determining if the portion of the input signal contains a pattern or noise in dependence upon the product.

11. A pattern recognition method, comprising:—
a segmentation process for segmenting an input signal comprising patterns to be recognised into portions, each portion containing at least one pattern to be recognised; and
a recognition process arranged to receive portions of the input signal from the segmentation process, and to recognise patterns contained therein;
wherein the segmentation process and the recognition process exchange control messages therebetween during their respective operations so as to control the respective operations thereof.

12. A method according to claim 11, wherein the segmentation process and the recognition process may operate on the same portion of the input signal substantially simultaneously.

13. A pattern recognition method according to claim 11, wherein upon segmenting a portion of the input signal the segmentation process indicates to the recognition process to commence recognition of the portion, the segmentation process then proceeding with further segmentation of the portion for a predetermined period thereafter, wherein if the segmentation process determines during that predetermined period that the previously segmented portion was incorrectly segmented, a control message is passed to the recognition to stop recognition of the portion.

14. A pattern recognition method according to claim 12, wherein upon segmenting a portion of the input signal the segmentation process indicates to the recognition process to commence recognition of the portion, the recognition process then proceeding with recognition of the portion, wherein if the recognition process determines no pattern can be recognised within the portion, it signals the segmentation process to continue further segmentation of the portion.

15. A method according to claim 14, wherein the segmentation process continues with further segmentation for a predetermined period of time.

16. A system for identifying portions of an input signal to be recognised in a pattern recognition process, comprising:—
receiving means for receiving an input signal to be recognised;
segmenting means for segmenting the input signal to determine the portions to be recognised; and
output means for outputting the segmented portions to a pattern recogniser
the system further comprising control means arranged in use to monitor one or more properties of the input signal to determine if environmental conditions affecting the generation of the input signal have changed, and if such changes are detected, cause the segmenting means to repeat operation.

17. A system according to claim 16, wherein the one or more properties include the energy contained within the input signal.

18. A system according to claim 16, further comprising matching means for matching a portion of the input signal to at least one predetermined noise model to determine a noise matching distance therebetween, wherein the one or more properties include the determined noise matching distance.

19. A system according to claim 18, further comprising matching means for matching a portion of the input signal to at least one predetermined pattern model to determine a pattern matching distance therebetween, wherein the one or more properties include the determined pattern matching distance.

20. A system according to claim 19, and further comprising calculating means for calculating a matching ratio of the noise matching distance and the pattern matching distance, wherein the one or more properties include the calculated ratio.

21. A system according to claim 20, wherein the control means further monitors changes in the matching ratio and changes in the signal energy, and detects changes in environmental conditions if the signal energy changes without a corresponding change in the matching ratio.

22. A system for detecting patterns to be subsequently recognised by a pattern recognition process within an input signal comprising patterns and noise, comprising:—
pattern matching means arranged in use to:—
i) match a portion of the input signal to one or more predetermined pattern models to determine a pattern matching distance therebetween; and
ii) match the portion of the input signal to one or more predetermined noise models to determine a noise matching distance therebetween; and
segmentation means arranged in use to determine if the portion of the input signal contains a pattern or noise in dependence upon the noise matching distance and the pattern matching distance.

23. A system according to claim 22, wherein the segmentation means further comprises calculating means for calculating a ratio of the noise matching distance to the pattern matching distance, and means for determining if the portion of the input signal contains a pattern or noise in dependence upon the calculated ratio.

24. A system according to claim 22, and further comprising means for measuring the energy in the portion of the input signal, wherein the segmentation means further determines if the portion of the input signal contains a pattern or noise in dependence upon the energy.

25. A system according to claim 22, wherein the segmentation means further comprises calculating means for calculating a ratio of the noise matching distance to the pattern matching distance, and means for determining if the portion of the input signal contains a pattern or noise in dependence upon the calculated ratio, the system further comprising means for measuring the energy in the portion of the input signal, wherein the segmentation means further determines if the portion of the input signal contains a pattern or noise in dependence upon the energy, wherein the segmentation means further calculates a product of the energy and the calculated ratio, and determines if the portion of the input signal contains a pattern or noise in dependence upon the product.

26. A pattern recognition system, comprising:—
a segmentation means for segmenting an input signal comprising patterns to be recognised into portions, each portion containing at least one pattern to be recognised; and
a pattern recognition means arranged to receive portions of the input signal from the segmentation means, and to recognise patterns contained therein;
wherein the segmentation means and the recognition means exchange control messages therebetween during their respective operations so as to control the respective operations thereof.

27. A system according to claim 26, wherein the segmentation means and the recognition means may operate on the same portion of the input signal substantially simultaneously.

28. A pattern recognition system according to claim 26, wherein upon segmenting a portion of the input signal the segmentation means indicates to the recognition means to commence recognition of the portion, the segmentation means then proceeding with further segmentation of the portion for a predetermined period thereafter, wherein if the segmentation means determines during that predetermined period that the previously segmented portion was incorrectly segmented, a control message is passed to the recognition means to stop recognition of the portion.

29. A pattern recognition system according to claim 26, wherein upon segmenting a portion of the input signal the segmentation means indicates to the recognition means to commence recognition of the portion, the recognition means then proceeding with recognition of the portion, wherein if the recognition means determines no pattern can be recognised within the portion, it signals the segmentation means to continue further segmentation of the portion.

30. A system according to claim 29, wherein the segmentation process continues with further segmentation for a predetermined period of time.
